(19) United States
(12) Patent Application Publication
(10) Pub. No.: US 2026/0084511 A1
(43) Pub. Date: Mar. 26, 2026

(54) DEVICE FOR INSERTING AND/OR REMOVING A POWER UNIT

(71) Applicant: Liebherr Mining Equipment Newport News Co., Newport News, VA (US)

(72) Inventors: Kevinkumar Patel, Newport News, VA (US); Joshua Brown, Newport News, VA (US); Simon Ardyna, Newport News, VA (US); Matthew Fuller, Newport News, VA (US); Fernando Seminario, Newport News, VA (US)

(21) Appl. No.: 18/891,748

(22) Filed: Sep. 20, 2024

(51) Int. Cl. B60K 5/10; B60K 1/00; B60K 8/00

(52) U.S. Cl. CPC B60K 5/10; B60K 1/00; B60K 8/00

(57) ABSTRACT

The present disclosure comprises a device for inserting and/or removing a power unit into and/or out of an installation space within a truck, comprising a rail configured to be inserted into the truck and to be anchored to an anchor point of the truck, the rail configured for moving the power unit on rollers along the rail for inserting and/or removing the power unit into and/or from the truck.

### BACKGROUND OF THE DISCLOSURE

The present disclosure relates to the handling of a power unit for installation and/or deinstallation in an installation space within a truck, in particular a dump truck.

The installation space for a power unit in a truck is usually surrounded by many elements of the truck once the truck is in its final configuration and therefore not easy to access after manufacture. During the manufacture of the truck, the power unit is usually installed into the frame of the truck while the elements of the truck surrounding the power unit are not yet in place. Deinstalling the power unit therefore is a cumbersome process.

With electrically powered trucks, the power unit comprises battery cells with a liftetime that is smaller than the lifetime of the truck, such that it is necessary to deinstall the power unit and replace it with a new power unit in regular intervals during the lifetime of the truck. Similar issues arise with combustion engine powered trucks, where engine lifetime is equally lower than truck lifetime, such that the power unit has to be replaced several times. Therefore, it is important to find ways to simplify and speed up the installation and deinstallation of the power unit.

Co-pending U.S. provisional applications 63/676,152 and 63/676,176, the content of which is included in this application by reference in its entirety, show a dump truck where the power unit arranged between the side beams of the frame of the truck as a single unit, and can be installed and removed via an installation opening provided at the front side of the truck.

### BRIEF SUMMARY OF THE DISCLOSURE

The present application addresses the issue of supporting the power unit while it is inserted into and/or removed from the installation space of a truck.

In a first aspect, the present disclosure provides a device for inserting and/or removing a power unit into and/or out of an installation space within a truck, comprising a rail configured to be inserted into the truck and to be anchored to an anchor point of the truck, the rail configured for moving the power unit on rollers along the rail for inserting and/or removing the power unit into and/or from the truck.

In a second aspect, the present disclosure provides a power unit comprising at least one roller unit configured to allow a rolling movement of the power unit on the at least one rail of a device of the first aspect.

In a third aspect, the present disclosure provides a truck comprising a power unit installed in an installation space within the truck, the truck further comprising an insertion space allowing insertion of the rail of a device of the first aspect, the truck further comprising an anchor point allowing connection of the rail to the anchor point.

In a fourth aspect, the present disclosure provides a method for inserting and/or removing a power unit into and/or out of an installation space within a truck using the device of the first aspect, the method comprising: inserting the at least one rail of the device into the truck and connecting it to an anchor point of the truck; supporting the power unit on the rail and; inserting and/or removing the power unit into and/or out of the installation space of the truck by moving the power unit on rollers along the rail.

The aspects of the present disclosure simplify the insertion and/or removal of a power unit into and/or out of an installation space within a truck.

The aspects of the present disclosure can in particular be applied to a dump truck having a frame and a dump body pivotably arranged on the frame.

The power unit may in particular provide electrical energy to at least one electrical propulsion motor of the truck.

The aspects of the present disclosure can in particular be applied to a battery electric dump truck. The power unit may in particular be a battery electric power unit.

The dump truck of the present disclosure may in particular be used on a mine site, in particular for open mining operations.

The truck of the present disclosure may have a maximum payload of 50 metric tons or more, in particular of 100 metric tons or more, in particular of 200 metric tons or more, in particular of 300 metric tons or more.

The truck of the present disclosure may have a an empty vehicle weight of 50 metric tons or more, in particular of 100 metric tons or more, in particular of 200 metric tons or more.

Embodiments of the present disclosure will now be described with reference to the following drawings.

### BRIEF DESCRIPTION OF THE DRAWINGS

The drawings show

FIG. 1 a perspective drawing of an embodiment of a device for inserting and/or removing a power unit according to the present disclosure,

FIG. 2 a side view of the device of FIG. 1 with an embodiment of a power unit of the present disclosure in a first step of an embodiment of a method of the present disclosure,

FIG. 3A a conceptual side view of the device and the power unit in the first step of the method,

FIG. 3B a conceptual side view of the device and the power unit in a second step of the method,

FIG. 3C a conceptual side view of the device and the power unit in a third step of the method,

FIG. 4 a side view of the device of FIG. 1 with the power unit in the third step,

FIG. 5 a side view of the device of FIG. 1 with the power unit in a fourth step of the method,

FIG. 6 a perspective view showing how the power unit is supported on the rail of the device,

FIG. 7 two perspective views showing an anchor point of an embodiment of a truck of the present disclosure and the connection of the anchor point of the truck with an anchor point of the device,

FIG. 8 a perspective view showing a support leg of the device,

FIG. 9 a perspective view of an embodiment of the truck of the present disclosure,

FIG. 10 a perspective view of the frame of the truck,

FIG. 11 a perspective view of the frame of the truck and the power unit installed thereto,

FIG. 12 a side view showing the rail of the device inserted between the frame and the power unit, and

FIG. 13 a front view showing the rail of the device inserted between the frame and the power unit.

### DETAILED DESCRIPTION OF THE DISCLOSURE

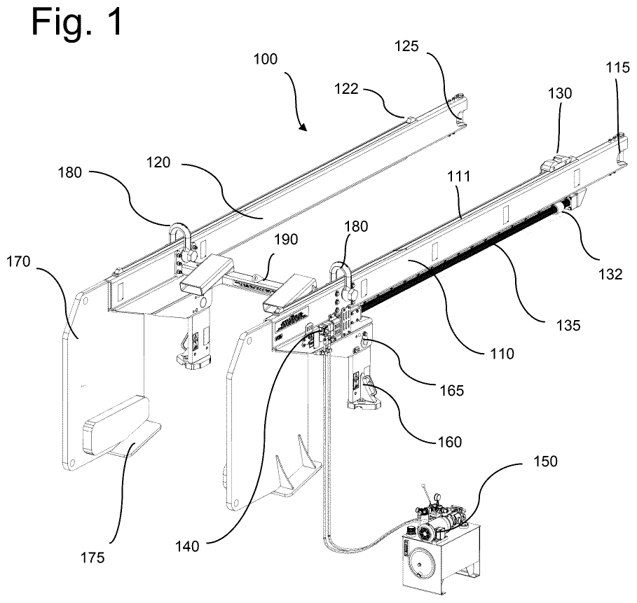

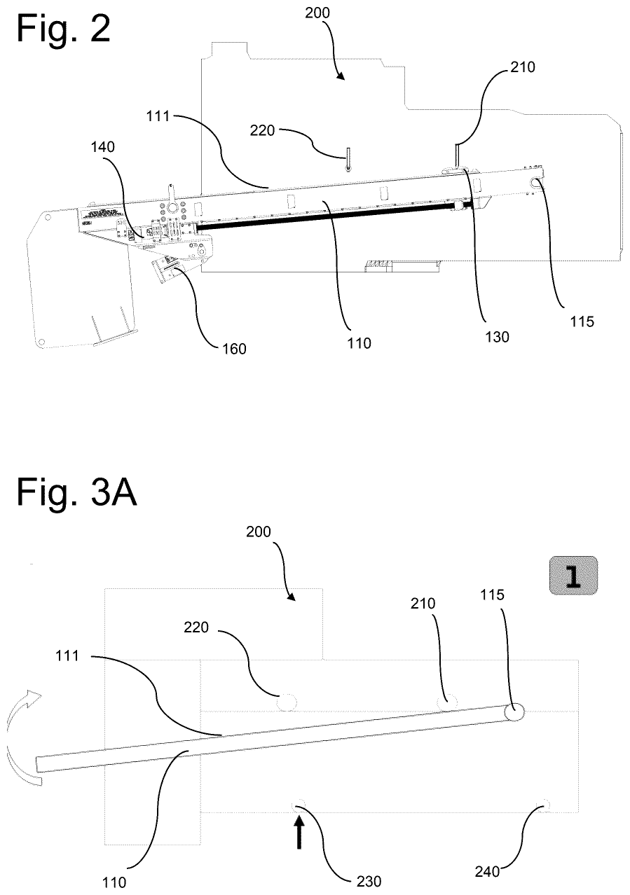

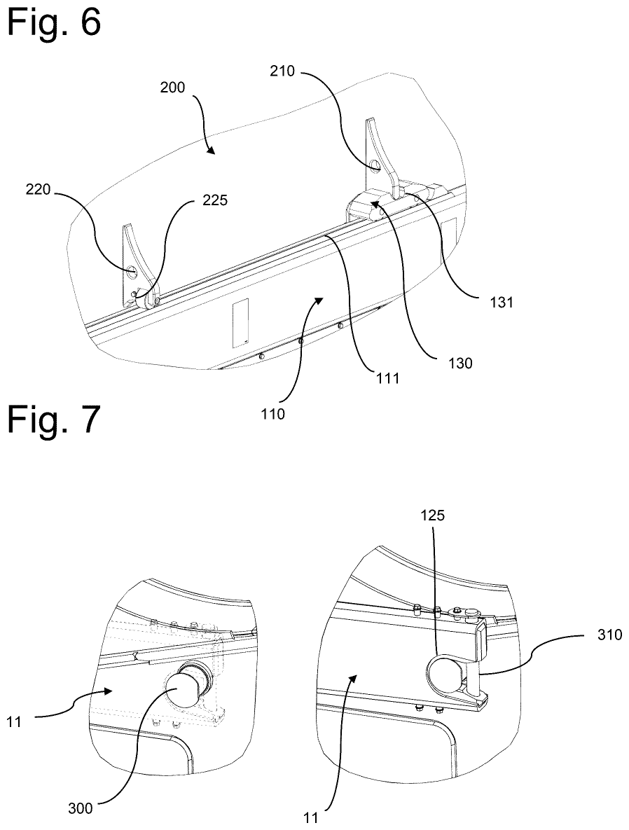

An embodiment of a device 100 for inserting and/or removing a power unit 200 into and/or out of an installation space within a truck is shown in FIG. 1, and an embodiment of a method for using the device for inserting and/or removing a power unit 200 into and/or out of an installation space within a truck is shown in FIG. 2 to 5. Details are shown in FIG. 6 to 8.

In a most general aspect, the device 100 for inserting and/or removing a power unit into and/or out of an installation space within a truck comprises a rail 110, 120 configured to be inserted into the truck and to be anchored to an anchor point 300 of the truck, the rail 110, 120 configured for moving the power unit on rollers 225 along the rail 110, 120 for inserting and/or removing the power unit 300 into and/or from the truck. By connecting the rail to an anchor point 300 of the truck, the rail is at least partly supported by the truck.

In the embodiment, the device comprises at least one roller unit 130 arranged on the rail 110, the roller unit 130 configured to receive a support element 210 of the power unit 200 and to roll along the rail 110.

In the embodiment, the device further comprises an actuator 140 coupled to the roller unit 130 for moving the roller unit 130 along the rail 110.

In particular, the actuator 140 is a motor driving a lead screw 135 extending along rail 110, with the roller unit 130 coupled to the lead screw 135 by a lead nut arranged on the roller unit 130.

In the embodiment, the lead screw 135 extends below the rails 110, with both ends of the lead screw 135 being rotatably held by bearing blocks attached to the bottom side of the rail 110. The end of the lead screw an the left hand side in FIG. 1 reaches through the bearing block and is coupled to the shaft of the motor 140 by a coupling.

As can be seen from FIGS. 1 and 6, the roller unit is guided on the rail 110, with rollers of the roller unit 130 arranged on a top part of the roller unit rolling on the upper side 111 of the rail 110 in the embodiment. In the embodiment, the roller unit 130 comprises two rollers. Further, the lead nut coupled to the lead screw 135 is arranged on a bottom part of the roller unit 130, with the top part and the bottom part being connected by a connection part. In the embodiment, the connection part is arranged on an inner side of the rail, i.e. an a side of the rail facing the power unit 200.

In the embodiment, the device comprises a portable energy source 150 for driving the motor 140, making the device autonomous and operable in the field without an external energy source.

In the embodiment, the motor 140 is a hydraulic motor. The portable energy source 150 is a hydraulic power pack unit comprising a compressor driven by a motor. The motor may be a combustion motor, with the portable energy source 150 comprising a tank, or the motor may be an electric motor, with the portable energy source 150 comprising a battery unit. In an alternative embodiment, the motor 140 is an electrical motor, and the portable energy source 150 is a battery unit.

As shown in FIGS. 1 and 5, the rail 110 is configured for guiding the rollers on which the power unit is moved on the rails. In the embodiment, the rail 110 comprises, on its top side, a groove for guiding the rollers.

As described above, the rollers may be arranged on a roller unit 130 of the device. Alternatively or in addition, rollers 225 may be arranged on the power unit 200.

In particular, as can be seen from FIG. 6, the power unit comprises a roller unit 220 on which a roller 225 is rotatably supported. In the embodiment, the roller 225 is guided on the top side 111 of the rail 110. In the embodiment, the roller unit 220 comprises a mounting plate attached to a side wall of the power unit 200, in particular by two rows of screws, with a bearing plate attached to the mounting plate extending in the vertical direction and having a bearing for the roller 225 at its bottom side.

As further shown in FIG. 6, the power unit further comprises a support element 210 supported on the roller unit 130 arranged on the rail 110. In particular, the support element 210 is supported on the top part of the roller unit 130.

In the embodiment, the roller unit 130 is provided with a catch groove 131 extending in a direction perpendicular to the extension of the rail 110, with a catch plate of the support element 210 sitting in the catch groove 131. In the embodiment, the support element 210 comprises a mounting plate attached to a side wall of the power unit 200, in particular by two rows of screws, with the catch plate attached to the mounting plate. The catch plate extends in the vertical direction, with a lower edge of the catch plate received in the catch groove 131.

In the embodiment, as can be seen in FIG. 6, the power unit comprises two support elements 210 and 220 for being supported on the rail 110 at two positions spaced apart. In the embodiment, one of the support elements is supported on the roller unit 130 of the rail, the other one is the roller unit 220 of the power unit.

In the embodiment, rail 110 is a first rail, and the device further comprises a second rail 120. In the embodiment, the first rail 110 and the second rail 120 extend in parallel and are connected and/or detachably connectable by a spreader beam 190 of the device, see FIG. 1. Detachably connecting the spreader beam 190 to the rails 110 and 120 reduces the storage space needed for the device when the device is not in use.

In the embodiment, as can be seen from FIG. 1, only the first rail 110 is provided with a roller unit 130. On the second rail, the power unit is supported by roller units arranged on the power unit 200. In particular, two roller units having the same configuration as the roller unit 220 may be provided on the power unit and may be supported on the second rail 120 in the same way as roller unit 220 is supported on the first rail 110. In particular, the second rail may be provided with a groove on its upper side for guiding the rollers of the respective roller units.

In the embodiment, the first rail 110 and the second rail 120 each have a stop 122 that limits the motion of the respective roller unit and therefore of the power unit at least in the direction of the free end of the rails. In the embodiment, the stops 122 are notches arranged on the top side of the rails, defining an end to the respective groove guiding the rollers.

In the embodiment, the first rail 110 and the second rail 120 are identical but for the second rail not having the roller unit 130 and the components for driving the roller unit 130.

In an alternative configuration, both rails may comprise a roller unit powered by an actuator. Further, in an alternative configuration, all the roller units may be part of the device, with the power unit being supported on the roller units in the same way as described for the roller unit 130. For example, at least two roller units may be provided on each rail, the roller units being connected by a connection rail on which the power unit is supported.

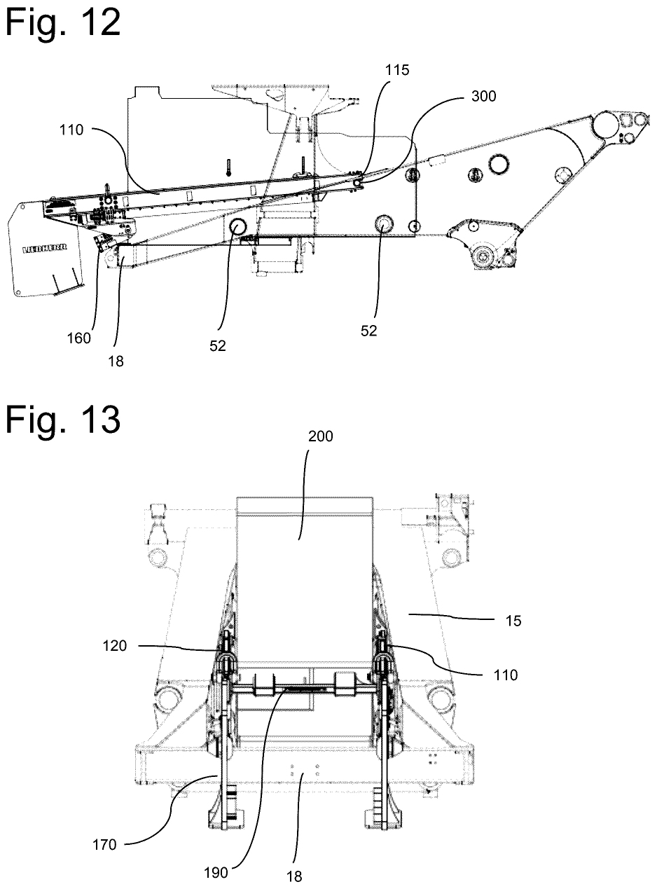

In the embodiment, as can in particular be seen from FIGS. 12 and 13, the rails 110 extend on both sides of the power unit 200 when attached to the truck, with the power unit 200 supported on the rails 110 by support elements 210, 220 attached to the sides of the power unit. In an alternative embodiment, the rails may extend below or above the power unit. In a further alternative embodiment, only a single rail may be used. In this case, the rail may extend above the power unit with the power unit hanging on the rail.

As can best be seen in FIG. 7, the rails 110 and 120 each comprise an anchor point 115 to be coupled to the anchor point 300 of the truck.

In the embodiment, the anchor points 115, 125 of the rails 110, 120 are arranged in a rear portion of the rails, and in particular on the free rear end of the respective rail 110, 120.

In particular, the anchor points 115, 125 are provided by jaws provided on the free end side of the rails 110, 120. The anchor points 300 on the truck are provided by pins, with the jaws being inserted onto the pins 300 for connecting the rails 110, 120 to the truck. The pins have a mushroom shape with a head securing the pins in the jaws in an axial direction of the pins.

Further, lock pins 310 are provided to close the jaws 115, 125 and to secure the pins 300 in the jaws, in particular while the rails are in a tilted orientation as described in the following.

Further, in the embodiment, the upper inside edge of the jaws 115, 125 extends at a downward angle with respect to the extension of the rail towards the open end of the jaws. Thereby, when the rail is arranged to extend horizontally, the upper inside edge of the jaws 115 extends downward in the direction towards the open end of the jaws, thereby securing the pins 300 in the jaws 115, 125 and thereby preventing the rails from sliding from the pins when supporting the power unit. The downward angle may be between 2° and 20°, and in particular between 4° and 12°.

In the embodiment, the lower inside edge of the jaws is parallel to the upper inside edge of the jaws 115, 125, the upper inside edge and the lower inside edge being connected by a circular receiving part in which the pin 300 rests.

As will be described in more detail in the following, the anchor points 300 of the truck are arranged on the frame of the truck.

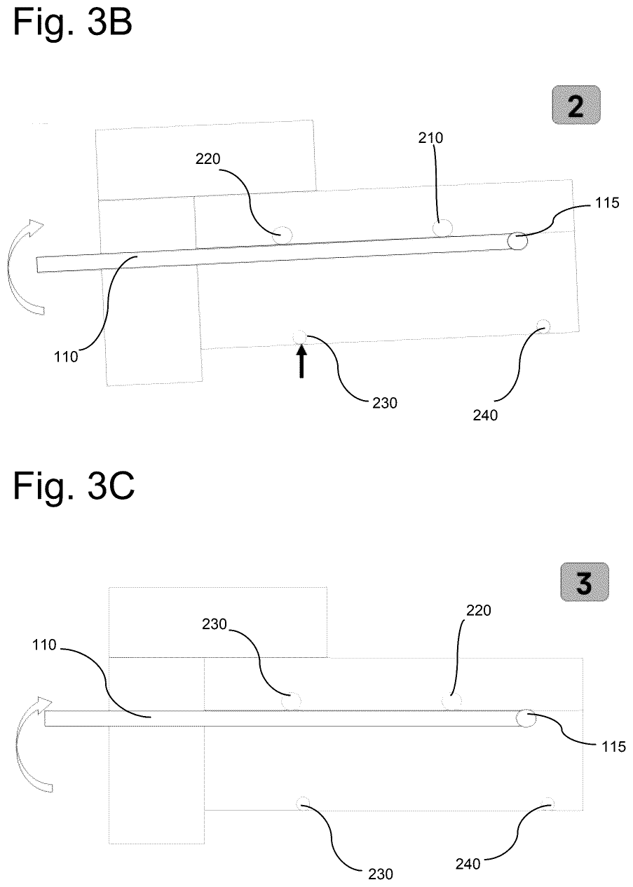

As can be seen from FIG. 3A to 3C and FIG. 7, the anchor point 300 of the truck and the anchor point 115, 125 of the device allow a pivot motion between the device and the truck around a horizontal axis. Thereby, the rail can perform a pivoting motion while it is already supported on the truck by the anchor point.

As shown in FIG. 1, the device comprises at least one lifting point 180 for lifting the device, the lifting point 180 allowing connection to a lifting device. In the embodiment, each rail is provided with a lifting point 180. The lifting points are provided by shackles 180 attached to the rails. In the embodiment, the lifting points 180 are attached to the hook of a crane for lifting the device, in particular by using a traverse connecting the lifting points 180 and hanging on the hook. The lifting points 180 and in particular the shackles may be removably attached to the device.

In the embodiment, the lifting points 180 are arranged in a front portion of the rails opposite the free end having the anchor points 115, 125. In particular, the lifting points 180 are arranged on the rails such that when the rails are attached to the truck, the power unit can be moved on the rails out of the truck without interfering with the lifting points 180.

In the embodiment, the lifting point is arranged on the device such that the rail extends, when the device is freely supported on the lifting point, with an angle different from zero to a horizontal direction. In particular, the rail may extend with an angle of less than +−20° and/or more than +−1° with respect to a horizontal direction. In particular, the angle may be less than +−10° and/or more than +−3° with respect to a horizontal direction. In the embodiment, the angle is 5°.

In particular, the lifting point 180 is arranged on the device such that the rail 110, 120 extends, when the device is freely supported on the lifting point 180, with an angle with respect to a horizontal direction such that a free rear end of the rail insertable into the truck is arranged higher than a front portion of the rail.

In the embodiment, the device comprises at least one counter weight 170 for maintaining the rails 110, 120 in a predefined position with respect to a horizontal direction when freely supported on the lifting points 180. In the embodiment, the counter weights 170 are arranged on the front ends of the rails 110, 120. In the embodiment, the counter weights are provided by plates extending downwards from the rails 110, 120. The counter weights are provided with a stand plate 165 on which the counter weights 160 will rest when lowered to the ground. The stand plates 165 are arranged at an angle with respect to the rails 110, 120 such that the plates are flush on the ground when the device rests on the ground with the forward free ends of the rails and the stand plates touching the ground.

The truck is configured such that the rails 110, 120 can be inserted into insertion spaces of the truck with the device freely supported on the lifting points 180. Thereby, a crane is sufficient to support the device and insert the rails into the truck.

The device may further be provided with tagline anchor points on the front and rear end of the rail, such as on the counter weights and the free rear ends. Taglines may be used to guide the device while it is freely supported on the lifting points and inserted into the truck or out of the truck.

As will be described in more detail in the following, in the embodiment, the device is configured such that by inserting the rails 110, 120 into the truck, connecting them to the anchor points 300 of the truck, and further lifting the device with a pivot motion around the anchor points 300 such that the rail extends horizontally, the power unit 200 is supported on the rails 110, 120 and is raised up.

As in particular shown in FIGS. 1, 4 and 8, in the embodiment, the device comprises at least one support element arranged on the device for supporting a front portion of the rail on the truck while the at least one rail extends horizontally. Thereby, by connecting the rail 110, 120 to the anchor point 300 of the truck on a rear side any by supporting the front portion of the rail on the truck by the support element, the device rests stably on the truck. Thereby, the truck will support the device while the power unit is rolled on the rail into or out of the truck, and there is no need to further support the device during this phase.

In the embodiment, the support element 160 is a support leg 160 attached pivotably to the device around a pivot axis 165. Thereby, the support element can be folded away not to interfere with the truck while the front end of the rails is raised in a pivot motion of the rails, and to fold out the support leg 160 into a support position where it rests on an element of the truck, in particular an element of the frame of the truck, when the rail has been raised.

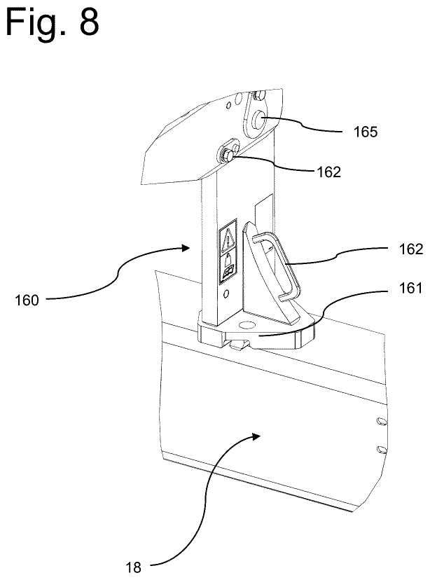

As shown in FIGS. 1 and 8, a support element 160 is provided on the front side of each rail, and in particular attached to a connection element provided below the rail 110, 120.

Each support element 160 comprises a stand plate 161 and, in the embodiment, a handle 162 for pivoting the support element.

As can be seen in FIG. 8, the support legs can be secured in their folded away parking position and/or their support position by a securing mechanism 162, such as a securing pin insertable into respective securing holes.

As described already above, the present disclosure provides, in a further general aspect, a power unit 200 comprising at least one roller unit 220 configured to allow a rolling movement of the power unit on the at least one rail 110, 120 the device.

In particular, the roller unit comprises at least one roller rotatably attached to the roller unit and configured to roll on the rail 110, 120.

Further details of the power unit 200 and how it is supported on the rails are already described above.

The power unit may in particular be a battery electric power unit for driving traction motors of the truck. It may in particular comprise a battery unit. Further details of the power unit are described in the following.

The present disclosure further comprises, in another general aspect, a truck comprising a power unit 200 installed in an installation space within the truck, the truck further comprising an insertion space allowing insertion of the rail 110, 120 of the device, the truck further comprising an anchor point 300 allowing connection of the rail to the anchor point.

The configuration of the anchor point 300 has already been described above. In particular, the anchor point may be a pin.

In the embodiment, as described more fully in the following, the truck comprises a frame 10, the anchor point 300 being arranged on the frame 10. Further, the frame 10 may comprise a counter support element 18 on which the support element 160 of the device is supported.

In further aspects of the present disclosure, the truck comprises the power unit and/or the device described above. In particular, the power unit may be mounted in the truck. The device may be provided as an accessory to the truck.

In a further aspect, the present disclosure comprises a set comprising the power unit and the device described above.

In a further aspect, the present disclosure comprises a method for inserting and/or removing a power unit 200 into and/or out of an installation space within a truck using the device 100 described above, the method comprising:
inserting the at least one rail 110, 120 of the device into the truck and connecting it to an anchor point 300 of the truck,
supporting the power unit 200 on the rail 11, 120 and
inserting and/or removing the power unit 200 into and/or out of the installation space of the truck by moving the power unit 200 on rollers along the rail 110, 120.

In an embodiment, the at least one rail 110, 120 is inserted into the truck in an inclined position where a rear end of the rail 110, 120 is arranged higher than a front portion of the rail, the method comprising, after the step of connecting the rail to the anchor point 300 of the truck in the inclined position, a step of raising the front portion of the rail 110, 120 to generate a pivot motion around the anchor point 300 until the rail 110, 120 extends horizontally.

In particular, in a method for removing the power unit out of the installation space within the truck, the power unit may be supported on the rail 110, 120 and may be raised up by the rail by raising the front portion of the rail 110, 120. In particular, the power unit may be raised from power unit mounts of the truck by raising the front portion of the rail.

The rails may be inserted into be truck in the inclined position below support element of the power unit, with the support element being supported by the rail when the rail pivots up in a horizontal position.

When the rail is in the horizontal position, the power unit may be rolled out of the truck on the rail.

In a method for inserting the power unit into the installation space within the truck, the power unit may be rolled into the installation space on the rail while the rail extends horizontally, the method further comprising the step of lowering the power unit onto power unit mounts by lowering a front portion of the rail.

In an embodiment, the method further comprises a step of supporting a front portion of the rail 110, 120 on a frame element 18 of the truck before moving the power unit on the rail.

In an embodiment, the step of supporting the power unit on the rail comprises supporting a support element of the power unit on a roller unit arranged on the rail and the step of moving the power unit on the rail comprises operating an actuator to drive the roller unit along the rail.

In an embodiment, after the step of supporting the power unit on the rail, the method comprises a step of disconnecting the power unit from a power unit mount of the truck.

Details of the method can be seen in FIG. 2 to 5.

In a first step not shown in the drawings, the device is arranged next to the truck. In particular, the two rails 110 and 120 may each be positioned on the ground supported on the stand plates 175 and the rear ends of the rails 110, 120, and connected to each other by mounting the spreader beam 190 to the rails. Further, the lifting points 180 may be mounted to the rails.

In a second step, the lifting points 180 are connected to a crane hook on which the device is raised such that it freely hangs on the lifting points. When freely hanging on the lifting points, the device levels out due to the position of its center of gravity in an inclined position where the rear ends of the rails 110, 120 are positioned higher than the front ends, as already described above. For this purpose, the center of gravity is positioned on a front side of the lifting points when the rails are extending horizontally.

Then, in a third step, still not shown, by moving the crane, the rails are inserted into insertion spaces of the truck while the device is still freely hanging on the lifting points 180. It may be guided by taglines connected to the device at appropriate positions. Due to the inclined position, the rails can be inserted into the truck below the support elements 210, 22o of the power unit 200.

The device is moved such that the anchor points 115, 125 on the rails are connected to the anchor points 300 of the truck. In particular, as described above, the jaws 115, 125 are inserted over the pins 300 and secured by inserting the lock pins 310.

FIGS. 2 and 3A show the device with the rails 110, 120 already inserted in the insertion space within the truck and with the anchor points 115, 125 arranged on the rear ends of the rails 110, 120 connected to the anchor points 300 on the truck.

By raising the device hanging on the lifting points 180, in particular by raising the crane hook on which the device is hanging, while the anchor points 115, 125 of the rails are connected to the anchor points 300 of the truck, the front end of the rails will rise in a pivot motion shown in FIG. 3A to 3C.

In FIG. 3A, the device is already raised slightly, such that the rear support elements on the power unit are supported on the rail. In particular, the catch plate of the support element 210 will come to rest inside the catch groove 131 of the roller unit 130. For this purpose, the roller unit 130 has to be placed at a position below the support element 210 such that the catch plate aligns with the catch groove. On the opposite side of the power unit, a roller of a rear roller unit attached to the power unit at the same position as support element 210 will come to rest on the upper side of rail 120.

As will be described in more detail in the following, the power unit is supported on the truck on front and rear power unit mounts 50 connected to mounting points 230 and 240 of the power unit.

For the further steps described in the following, the rear mounting points 240 and the front mounting points 230 are loosened to allow some relative movement of the power unit with respect to the truck while still securing the power unit to the truck.

By further raising the device, the rear end of the power unit is raised because the rear support elements 210 supported on the rails is raised by the pivot motion of the rails, as shown in FIG. 3B, with the rear mounting points 240 raised from the rear power unit mounts of the truck. During this pivot motion, the power unit 200 rests with the front mounting point 230 on the front power mount of the truck and with the rear support elements 210 on the rails.

When further raising the device, the front support elements 220 equally become supported on the rails. This situation is shown in FIG. 3B.

As shown in FIG. 3C, by further raising the device, the front end of the power unit is now equally raised, with the front mounting points 230 raised from the front power unit mounts of the truck, until the rails extend horizontally.

In the final stage of lever up motion, with the rails extending horizontally, the power system will be lifted by a specified distance sufficient to clear the mounting points 230, 240 from the front power unit mounts such that they can be completely detached from each other. In an embodiment, the power unit is raised more than 1 cm and/or less than 20 cm, in particular more than 2 cm and less than 10 cm.

As can be seen in FIG. 2, showing the situation of FIG. 3A in more detail, when the rails are inserted into the truck, the support legs 160 are folded away frontwards in their parking position in order to avoid a collision with the frame.

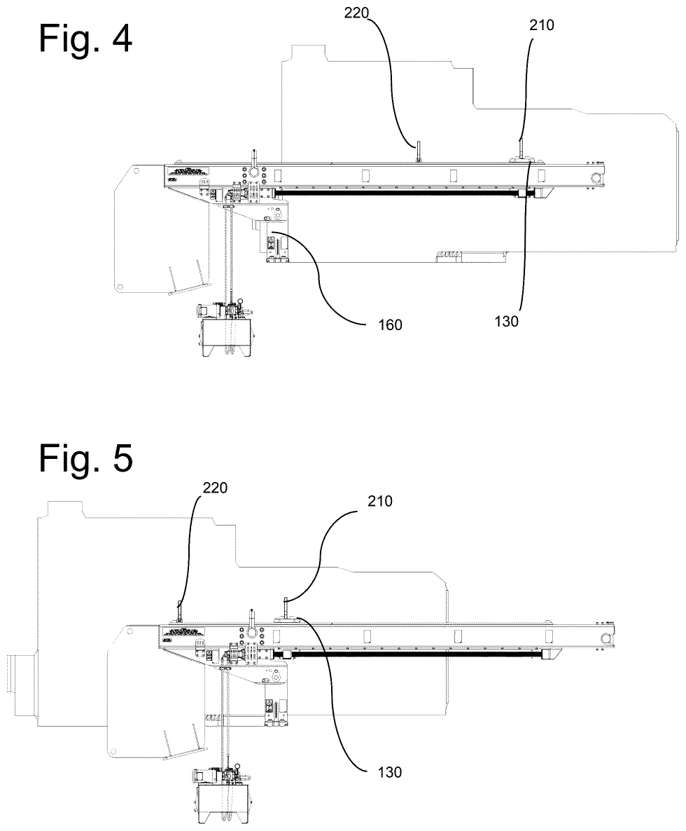

Further, as can be seen FIG. 4, showing the situation of FIG. 3C in more detail, when the rails have been raised to a horizontal position, the support legs 160 are folded rearwards to their support position where they are supported on an element of the frame. In order to allow the pivot movement of the support legs 160, the front end of the rails may be raised above horizontal, the support legs 160 folded out and the front ends then lowered again for the support legs to rest on the frame.

When the device is in a horizontal position and supported on the frame by the support legs 160 and the anchor points 115, 125, and supports the power unit, the mounting points 230, 240 are completely decoupled from the power unit mounts of the truck.

Further, the portable energy source 150 is connected to the motor 140. In particular, the hydraulic power pack unit 150 is connected by hydraulic lines to the hydraulic motor 140 on the device 10.

After the installation of the device into the truck and raising the power unit, rollout operation may begin. As shown in FIGS. 4 and 5, for moving the power unit 200 supported on the rails 120, 120, the actuator 140 is operated to drive the roller unit 130 along the rail, thereby moving the power unit along with it.

The power unit 200 is moved on the rails to the position shown in FIG. 5, where it can be connected to a crane and lifted from the rails and out of the truck.

It may be necessary to stop the rollout at an intermediate position to remove elements of the power pack such as the front mounting point or the corresponding bracket in order to allow the power unit to pass through the installation opening. Further, stiffening members may be attached to the power unit to improve stability.

For inserting a new power unit into the truck, the above described steps are performed in the opposite order, starting from the situation shown in FIG. 5 and reversing to the situation shown in FIG. 2.

In particular, with the device attached to and supported on the truck as shown in FIG. 5, the new power unit is lowered by a crane on the rails of the device such that the rear support element 210 rest on the roller unit 130 and the remaining support elements such as support element 220 rests with their rollers on the upper side of the rail.

By operating the actuator, the power unit is rolled into the truck until the mounting points 230, 240 can be loosely connected to the power unit mounts of the truck. The device is then lowered until the power unit is again supported on the power unit mounts of the truck. The support leg is folded away, preferably shortly before the front mounting points 230 come to rest on to the power unit mounts of the truck. When both the front and the rear mounting points 230, 240 rest on the power unit mounts of the truck, they are fastened to the power unit mounts of the truck.

The anchor points of the device are then disconnected from the anchor points of the truck and the device is removed from the truck.

In case of power loss or any other type of anomaly, the fail-safe design described in the following as a possible option, will allow the field technician to disengage the roller unit 130 from the lead screw 135 and slide out/in the battery pack by other means.

In particular, the lead nut 132 may be detachably connected to the roller unit 130. For example, it may be bolted to the bottom part of the roller unit 130 by a bolt extending in parallel to the lead screw 135. A hole provided on the lead nut 132 may be provided in a protrusion extending from the circumference of the lead nut 132. When the bolt is detached and the lead nut is rotated for a predetermined angle, the protrusion will come clear from a counter element on the roller unit 130 and the roller unit will be free to move.

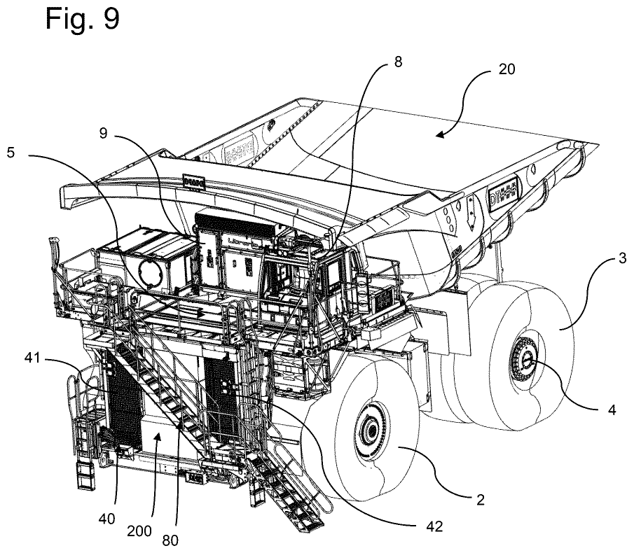

Details of the truck, as well as how the power unit is inserted and integrated into the truck, are provided in the following with respect to FIG. 9 to 13.

We note that the terms rear and front have been used above for the elements of the power unit and the truck in the same way as for the device, i.e. with the direction from front to rear defined by the direction from the front of the rails where they are hanging on the lifting points to the free rear ends of the rails inserted into the truck. As will be described in the following, these directions also correspond to the front and rear directions of the truck when the power unit is inserted from a front side of the truck. If the power unit is not inserted into the truck from the front, the directions used above may differ from the front and rear directions of the truck.

In a general aspect, the embodiments of the truck of the present disclosure comprise a frame 10 and a power unit 200 providing electrical energy to at least one electrical propulsion motor 4 of the truck. If the truck is a dump truck, it further comprises a dump body 20 pivotably mounted on the frame 10.

If the truck is a battery electric truck, the power unit 200 comprises a battery. If the truck is combustion electric, the power unit comprises a combustion engine driving a generator. The power unit may also comprise fuel cells for generating electrical energy from hydrogen and a hydrogen tank.

If the truck is a battery electric truck, the power unit 200 may not comprise a combustion engine, such that the dump truck is a fully electric dump truck. Further, the batteries of the dump truck may be the only on-board power source of the truck. However, the dump truck may additionally comprise a trolley system to provide electrical energy via power lines and the trolley system.

In an embodiment, the power unit 200 may comprise a battery unit for powering electric traction motors of the truck. The power unit may further comprise a power distribution cabinet and/or a thermal conditioning unit.

As shown in FIG. 9, the truck comprises at its front side an installation opening for inserting the power unit 200 into an installation space within the truck. Further, as shown in FIG. 13, there are insertion openings on both sides of the power unit when the power unit is installed in the installation space, with allow insertion of the rails 110, 120 of the device 100.

Further, the frame 10 comprises a front cross beam 18, which is the bumper beam in the embodiment, on which the device is supported by the support legs 160. As can be seen in FIG. 12, by folding the support legs towards the front, they come clear of the front cross beam 18 when the rails are inserted. The lifting points and the spreader beam of the device remain in front of the power unit when the rails are connected to the frame.

As shown in FIG. 9, the truck comprises a stair element 80 extending in front of the installation opening. This stair element 80 is detachably connected to the truck and has to be dismounted from the truck for removing a power unit and inserting a new power unit.

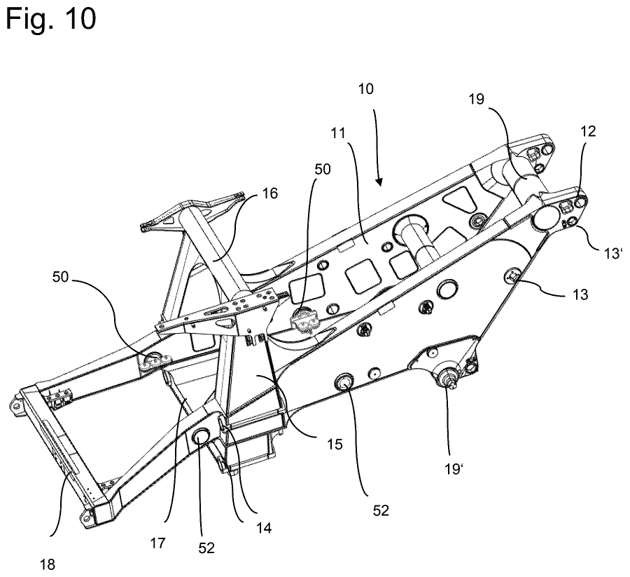

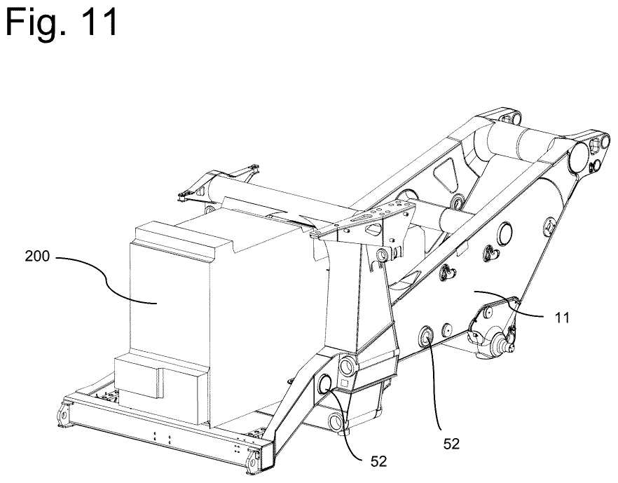

Further, as shown in FIGS. 10 and 11, the frame 10 comprises two side beams 11 extending in a longitudinal direction of the battery electric dump truck. In the embodiment, the side beams extend from a front end of the dump truck to a rear end, with the dump body being pivotably mounted to pivot mounts 12 arranged at the rear end of the sides frames.

As can be seen from FIGS. 11 and 12, the power unit 30 is arranged between the side beams 11 of the frame. Further, the mounting points 230 and 240 described above are connected to the power units mounts 50 that support the power unit on the frame.

In the embodiment, as shown in FIGS. 12 and 13, the anchor points 300 of the truck are provided on the inner sides of the side beams 11 facing the power unit. Therefore, the rails 110, 120 are inserted between the power unit and the inner sides of the side beams at least with their rear ends.

Further, as shown in FIG. 10, the frame 10 comprises an upper bridge member connecting the two side beams 11 in a lateral direction, the upper bridge member comprising side pillars 15 extending upwards from the side beams 11 and an upper cross beam 16 connecting the side pillars. As shown in FIG. 11, the power unit extends below the upper cross beam 16. As shown in FIG. 13, the rails 110, 120 extend between the power unit and the side pillars 15.

Further, at the same longitudinal position of the frame as the side pillars 15, the side beams are connected by a lower bridge member formed by a lower extension of the side pillars connected by a lower cross beam 17. The upper bridge member and the lower bridge member therefore together form a frame structure extending in an up-down direction and a lateral direction of the battery electric dump truck. The power unit extends through this frame structure.

With the above configuration, it is not possible to insert the power unit into the installation space extending below the upper cross beam 16 from above. The device of the present disclosure allows to insert the power unit from the front side, by rolling the power unit on the rails beneath the upper cross beam 16 into its mounting position.

Further details of the embodiment of the battery electric dump truck and the frame shown in FIGS. 9 and 10 are described in the following. However, the aspects of the present disclosure described in the following may also be implemented with other embodiments of a battery electric dump truck or a frame.

In the embodiment, the frame or chassis 10 is a steel construction formed by welding steel elements to each other. Some of the steel elements may be casted elements, others may be steel plates. The beams of the frame may have, in cross section, a box construction, a T-construction of a H-construction.

In the embodiment, the truck shown in FIG. 1 comprises front wheels 2 and rear wheels 3, with at least the rear wheels driven by the propulsion motors 4. The front wheels 2 are steered by a steering system.

On a level above the front wheels 2, the truck comprises a deck 5 carrying an operator cabin 8 and/or a control cabinet 9. Further functional units may be mounted on the deck 5.

In a manual mode, the truck is controlled by an operator from the operator cabin 8, using manual control elements such as a steering wheel, an accelerator pedal and/or a brake pedal for controlling a propulsion system and a steering system of the truck and thereby the speed and the direction of the truck.

The truck may also comprise an autonomous mode, wherein a controller of the truck autonomously controls the propulsion system and a steering system of the truck and thereby the speed and the direction of the truck. For example, the controller may be configured to autonomously control the truck along a mission from a loading site to an unloading site or vice versa. The controller may further be configured to autonomously control the truck to travel to a charging station and autonomously perform a charging operation in collaboration with the charging station. In autonomous mode, the controller of the truck may be in communication with a central mission controller to receive the missions to be performed by the truck.

The controller may comprise a microprocessor and a computer program stored on non-transitory memory, the computer program comprising code that will, when executed on the microprocessor, provide the functionality described above and in the following. The controller may be connected to input devices located in the operator cabin of the truck, and may control actuators of the truck such as steering actuators and the electric propulsion motors 4 for controlling steering and propulsion.

On a front side of the truck, a radiator unit 40 is provided. Further, in front of the radiator unit 40, the staircase element 80 leads to the deck 5.

The deck and the operator cabin are mounted on the upper cross beam 16 of the upper bridge member.

Further, connection points 14 for the suspension system of the front wheels 2 are provided on the pillars 15. A suspension system of the rear wheels is mounted to connection points 13, 13′ provided on the side beams 11.

In the embodiment, the side beams 11 are connected in the lateral direction by a first rear cross member 19 and a second rear cross member 19′.

In the embodiment, the side beams 11 have, in side view, an essentially triangular shape extending between a front end, the first rear cross member 19 and the second rear cross member 19′. A longer side of the triangular shape is directed to an upper side, a first shorter side is directed to a lower side, and a second shorter side is directed to the rear. The longer side therefore extends upwards in a front-rear direction.

In the embodiment, the first rear cross member 19 is arranged at a rear corner adjacent to the pivot mounts 12 of the dump body and the second rear cross member 19′ is arranged at a lower corner of the triangular shape and comprises at its lateral ends pins for carrying the lower ends of dump hoist cylinders for hosting the dump body 20.

In the embodiment, front ends of the side beams 11 are connected by the front cross member 18.

As shown in FIG. 9, the truck comprises a split radiator unit 40 comprising two radiator columns 41 and 42 spaced apart from each other, with the installation opening 45 for the power unit 30 being arranged between the radiator columns 41 and 42. Thereby, the power unit 30 can be installed or de-installed from the truck without having to de-install the radiator unit.

In the embodiment, the power unit may be inserted into an installation space between the side beams 11 of the frame 10 or removed from this installation space with the radiator unit still mounted to the frame, via the installation opening provided between the radiator columns 41 and 42.

In the embodiment, the radiator unit is arranged on a front side of the truck. In the embodiment, as shown in FIG. 9, when the power unit 200 is installed to the truck, a front side of the power unit 200 is exposed to the surroundings and therefore a front surface of the power unit forms part of the front surface of the truck. In the embodiment, the front side of the power unit 200 extends in front of or between the radiator columns 41 and 42. In the embodiment, the front side of the power unit 200 closes the installation opening 45.

In the embodiment, the front side of the power unit is formed by at least one a casing element of the power unit.

The staircase element 80 extending in front of the front side of the power unit provides access to the deck 5 from the ground and extends diagonally across the front of the truck.

As shown in FIG. 10, the power unit mounts are cantilevered mounts 50 attached to the frame 10. In particular, in the embodiment, the cantilevered mounts 50 are attached to the inner side walls of the side beams 11 of the frame 10. The cantilevered mounts 50 are connected to frame tubes 52 extending in a lateral direction through the frame, and in particular through the side beams 11 of the frame, with the cantilevered mounts 50, 50′ being either integrally formed with the frame tubes or bolted to the frame tubes 52. The frame tubes improve the stability of the sides beams 11 where the cantilevered mounts 50, 50′ are attached. The frame tubes are welded to the surrounding steel plates of the side beams 11.

In the embodiment, the power unit 200 may comprise side brackets arranged on its lateral sides, the side brackets providing the mounting points connected to the cantilevered mounts 50. In particular, the mounting points may be connected to the cantilevered mounts 50 by bolts and rubber bearings.

As shown in FIG. 11, the power unit 200 comprises a front portion and a rear portion, the rear portion having a first upper surface extending below a level of the upper cross beam 16, and the front portion having an second upper surface extending at a level in front of the upper cross beam 16 and/or above the upper cross beam 16. In the embodiment, there is a step portion between the first upper surface and the second upper surface, the step portion extending in front of the upper cross member 16 in an up-down direction.

The truck and the power unit may in particular be configured as shown in co-pending U.S. provisional applications 63/676,152 and 63/676,176, the content of which is included in this application by reference in its entirety.

1. A device for inserting and/or removing a power unit into and/or out of an installation space within a truck, comprising
a rail configured to be inserted into the truck and to be anchored to an anchor point of the truck,
the rail configured for moving the power unit on rollers along the rail for inserting and/or removing the power unit into and/or from the truck.

2. The device of claim 1, comprising at least one roller unit arranged on the rail, the roller unit configured to receive a support element of the power unit and to roll along the rail.

3. The device of claim 2, further comprising an actuator coupled to the roller unit for moving the roller unit along the rail.

4. The device of claim 1, wherein the rail is configured for guiding the rollers, the rollers being arranged on the power unit and/or a roller unit of the device.

5. The device of claim 1, the rail comprising an anchor point to be coupled to the anchor point of the truck, the anchor point of the truck and the anchor point of the device allowing a pivot motion between the device and the truck around a horizontal axis.

6. The device of claim 5, wherein the device comprises at least one lifting point for lifting the device, the lifting point allowing connection to a lifting device.

7. The device of claim 6, wherein the lifting point is arranged on the device such that the rail extends, when the device is freely supported on the lifting point, with an angle of less than +−20° and/or more than +−1° with respect to a horizontal direction.

8. The device of claim 7, wherein the lifting point is arranged on the device such that the rail extends, when the device is freely supported on the lifting point, with an angle with respect to a horizontal direction such that a free rear end of the rail insertable into the truck is arranged higher than a front portion of the rail.

9. The device of claim 1, wherein the device is configured such that by inserting the rail into the truck, connecting it to the anchor point of the truck, and further lifting the device with a pivot motion around the anchor point such that the rail extends horizontally, the power unit is supported on the rail and is raised up.

10. The device of claim 1, comprising at least one support element arranged on the device for supporting a front portion of the rail on the truck while the at least one rail extends horizontally, wherein the support element is a support leg attached pivotably to the device, and/or a counter weight for maintaining the rail in a predefined position with respect to a horizontal direction when freely supported on a lifting point.

11. The device of claim 1, wherein the rail is a first rail, the device comprising at least a second rail, wherein the first and the second rail are connected and/or detachably connectable by a spreader beam of the device.

12. A power unit comprising at least one roller unit configured to allow a rolling movement of the power unit on the at least one rail of a device of claim 1.

13. A truck comprising a power unit installed in an installation space within the truck, the truck further comprising an insertion space allowing insertion of the rail of a device of claim 1, the truck further comprising an anchor point allowing connection of the rail to the anchor point.

14. The truck of claim 13, comprising a frame, the anchor point being arranged on the frame.

15. The truck of claim 13 comprising a power unit comprising at least one roller unit configured to allow a rolling movement of the power unit.

16. A method for inserting and/or removing a power unit into and/or out of an installation space within a truck using the device of claim 1, the method comprising:
inserting the at least one rail of the device into the truck and connecting it to an anchor point of the truck,
supporting the power unit on the rail and
inserting and/or removing the power unit into and/or out of the installation space of the truck by moving the power unit on rollers along the rail.

17. The method of claim 16, wherein the at least one rail is inserted into the truck in an inclined position where a rear end of the rail is arranged higher than a front portion of the rail, the method comprising, after the step of connecting the rail to the anchor point of the truck, a step of raising the front portion of the rail to generate a pivot motion around the anchor point until the rail extends horizontally.

18. The method of claim 16 for removing the power unit out of the installation space within the truck, wherein the power unit is supported on the rail and is being raised up by the rail by raising the front portion of the rail.

19. The method of claim 16 for inserting the power unit into the installation space within the truck, wherein the power unit is rolled into the installation space on the rail, the method further comprising the step of lowering the power unit onto power unit mounts by lowering a front portion of the rail.

20. The method of claim 16, comprising a step of supporting a front portion of the rail on a frame element of the truck before moving the power unit on the rail.
